(19) United States
(12) Patent Application Publication
(10) Pub. No.: US 2023/0029876 A1
(43) Pub. Date: Feb. 2, 2023

(54) LOCATION-AWARE REMINDERS

(71) Applicant: Cerence Operating Company, Burlington, MA (US)

(72) Inventors: Nils Lenke, Aachen (DE); Andreas Kellner, Aachen (DE); Geert-Jan Kruijff, Aachen (DE)

(21) Appl. No.: 17/789,538

(22) PCT Filed: Dec. 23, 2020
(86) PCT No.: PCT/US2020/066845

§ 371 Date: Jun. 28, 2022

Related U.S. Application Data
(60) Provisional application No. 62/956,743, filed on Jan. 3, 2020.

(51) Int. Cl. G06Q 10/10; G08G 1/0968; G06Q 10/06

(52) U.S. Cl. CPC G06Q 10/109; G08G 1/096838; G06Q 10/06311; G06Q 50/30

(57) ABSTRACT

A method for managing location-aware reminders in an automobile includes monitoring a geographic location of the automobile using a computer system installed in the vehicle. The computer system detects that the automobile has entered a geographic region associated with a location-aware reminder and issues a reminder message associated with the location-aware reminder to a driver of the automobile based on the detecting.

### CROSS-REFERENCE TO RELATED APPLICATIONS

This application claims the benefit of U.S. Provisional Application No. 62/956,743, filed on Jan. 3, 2020, which is incorporated herein by reference.

### BACKGROUND

Conventional reminders are often attached to a point in time. For example, one might use their smartphone to set a reminder for a time in the future (e.g., remind me to call the doctor's office tomorrow morning).

### BRIEF SUMMARY OF THE DISCLOSURE

In some situations, there is a need for reminders that are tied to a specific location, where it is not known when that location will be revisited. For example, when one leaves clothing at a dry cleaner in the morning and may need to remember to pick them up on the way home in the evening.

Aspects described herein relate to mechanisms for attaching reminders addressed to oneself or others to locations or points of interest while driving in a vehicle. The reminders are brought to the attention of the addressee the when they are in the vicinity of the location or point of interest to which the reminder is attached.

In a general aspect, a method for managing location-aware reminders in an automobile includes monitoring a geographic location of the automobile using a computer system installed in the vehicle, detecting, using the computer system, that the automobile has entered a geographic region associated with a location-aware reminder and issuing, from the computer system, a reminder message associated with the location-aware reminder to a driver of the automobile based on the detecting.

Aspects may include one or more of the following features.

Detecting that the automobile has entered a geographic region may include detecting that the automobile has entered a fixed geographic region specified in the location-aware reminder. Detecting that the automobile has entered a geographic region may include detecting that the automobile has entered a geographic region associated with one of a plurality of possible points of interest associated with the location-aware reminder.

Issuing the reminder message may include audibly emitting the reminder message from a loudspeaker of the reminder system. Issuing the reminder message may include presenting a textual representation of the reminder message on a display of the navigation system. The detecting may include detecting that an addressee of the location-aware reminder is present in the automobile. The detecting may include accessing a location-aware reminder database. The location-aware reminder database may be stored in the automobile. The location-aware reminder database may be stored on a remote server.

The method may include receiving, at the navigation system, a command to create the location-aware reminder, processing the command to generate the location-aware reminder, and storing the location-aware reminder in a location-aware reminder database. Processing the command to generate the location-aware reminder may include determining an identity of a sender of the location-aware reminder, an addressee of the location-aware reminder, and information related to one or more geographic regions associated with the location-aware reminder. The addressee of the location-aware reminder may be different from the sender of the location-aware reminder. The command may be received as a voice command.

The computer system may include a navigation system configured to monitor the geographic location of the vehicle. The computer system may include an infotainment system including a display through which the reminder message is issued.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is a navigation system receiving a request to set a location-aware reminder.

FIG. 2 is a schematic diagram of the navigation system of FIG. 1 configured to form a location-aware reminder.

FIG. 3 is a schematic diagram of the navigation system of FIG. 1 configured to issue a location-aware reminder.

FIG. 4 is the navigation system of FIG. 1 issuing a location-aware reminder.

### DETAILED DESCRIPTION

### 1 Overview

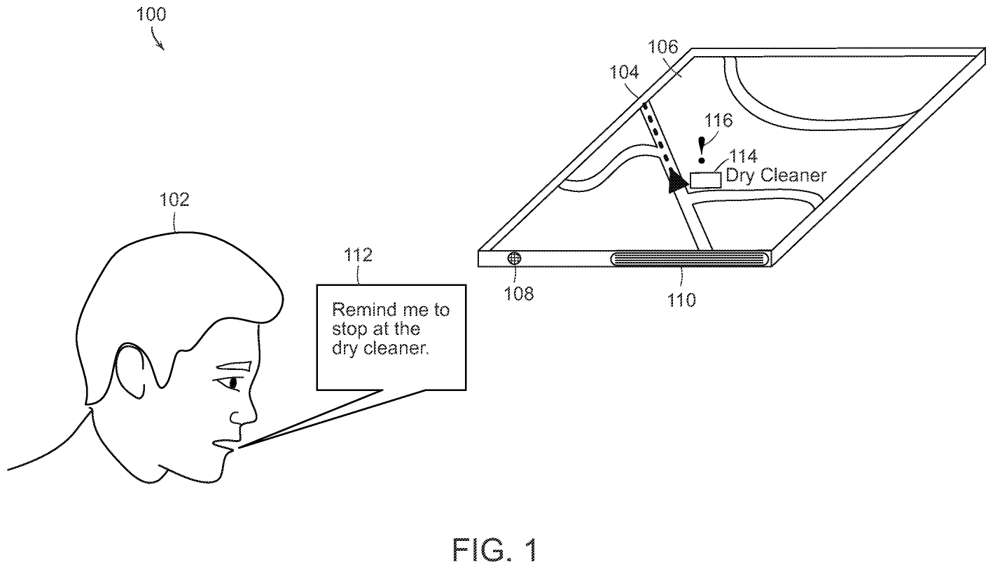

Referring to FIG. 1, in one example of a location-aware reminder system 100, a driver 102 interacts with a navigation system 104 in a vehicle (e.g., an automobile, not shown). The navigation system 104 includes a display 106, a microphone 108, and a loudspeaker 110.

Very generally, the driver 102 speaks commands to the navigation system 104 for setting location-aware reminders. An acoustic signal associated with those spoken commands are sensed by the microphone 108 and processed by the navigation system 104 (as is described in greater detail below) to form the location-aware reminders. The location-aware reminders are stored by the navigation system 104 for later use.

When the vehicle travels to a vicinity of a location associated with a stored location-aware reminder, the navigation system 104 delivers a reminder message associated with the location-aware reminder to an addressee associated location-aware reminder. In some examples, the reminder message is delivered as one or both of an acoustic signal via the loudspeaker 110 and a textual display via the display 106.

In the example of FIG. 1, as the driver 102 departs a dry cleaner's location 114, the driver 102 speaks a command 112 instructing the navigation system 104 to remind the driver 102 to “stop at the dry cleaner.” The microphone 108 senses the spoken command and the navigation system 104 processes the command 112 to form and store a location-aware reminder. In some examples, a visual indicator 116 (e.g., an exclamation point) is displayed next to the reminder's location to indicate that the location is associated with a reminder.

### 2 Reminder Formation

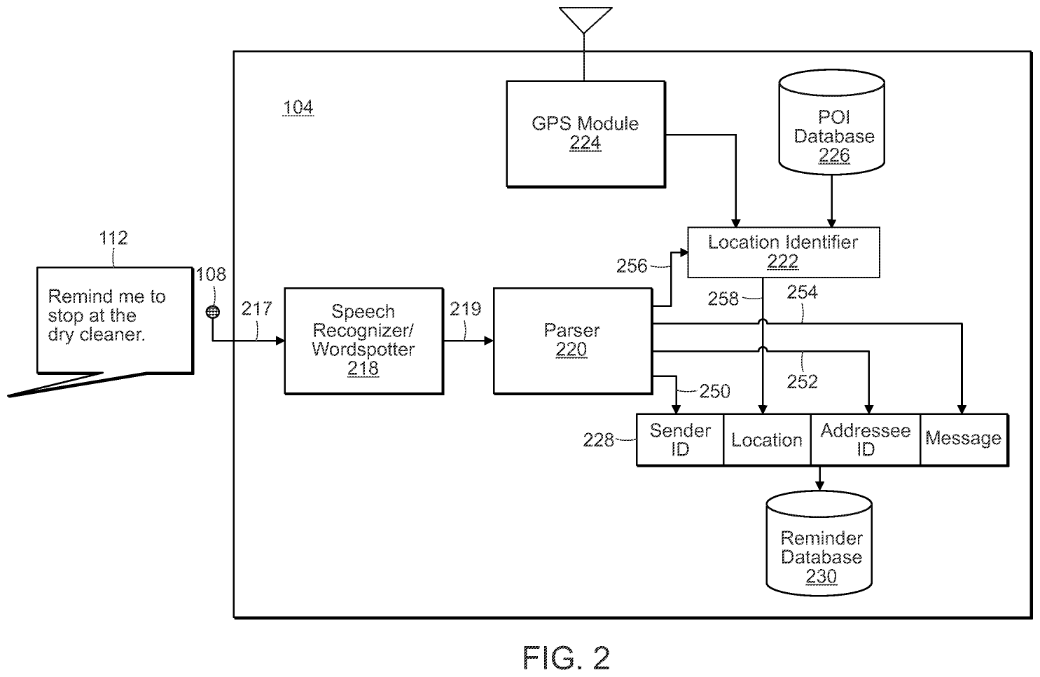

Referring to FIG. 2, the spoken command 112 is sensed by the microphone 108 to generate a sensor signal 217 which is provided to a speech recognizer/wordspotter module 218. The speech recognizer/wordspotter module 218 processes the sensor signal 217 to generate a parseable (e.g., textual) representation 219 of the spoken command, which is provided to a parser 220.

The parser 220 processes the textual representation 219 of the spoken command to identify a sender 250 of the reminder (referred to as “Sender ID”), an addressee 252 for the reminder (“Addressee ID”), a reminder message 254 (referred to as “Message”), and location information 256 associated with the reminder.

In the present example, the spoken command 112 includes the phrase “remind me,” so the parser 229 determines sender 250 of the reminder and the addressee 252 for the reminder to be the current driver. The spoken command includes the phrase “stop at the dry cleaner,” so the parser 220 sets the reminder message 254 as either a textual or audio version of the phrase “stop at the dry cleaner.”

The location information 256 associated with the reminder is provided to a location identifier 222 to identify a reminder location 258 (referred to as “Location”). In general, the location information 256 specifies whether the location identifier 222 should determine the reminder location 258 from a global position system (GPS) module 224, a point of interest (POI) database 226, or both.

In the present example, a fixed location approach is used. The spoken command 112 indicates that the address is “the dry cleaner,” so the location identifier 222 queries the geographic location of the vehicle using the GPS module 224 and then queries the POI database 226 to identify dry cleaner points of interest nearby that geographic location. The reminder location 258 is set to the dry cleaner 114 (or geographic coordinates associated with the dry cleaner 114) closest to the vehicle when the reminder is set.

In another example of the fixed location approach, the location information 256 associated with the reminder indicates that the location identifier 222 should query only the global positioning system (GPS) module 224 to determine the reminder location 258. For example, if the spoken command 112 were “remind me to stop here,” then the parser 220 would identify the word “here” in the textual representation 219 of the spoken command, indicating that the location identifier 222 should query the GPS module 224 to obtain the reminder location 258.

In other examples, a POI based approach is used where the location information 256 associated with the reminder indicates that the location identifier 222 should query only the POI database 226 to determine one or more classes of points of interest (e.g., shop types or brands) to associate with the reminder location 258. For example, if the spoken command 112 were “stop at a grocery store and get milk,” then the parser 220 would identify the phrase “a grocery store” in the textual representation 219 of the spoken command, indicating that the location identifier 222 should set the reminder location 258 to, for example, any grocery store that the vehicle encounters.

Once the sender 250 of the reminder, the reminder location 258, the addressee 252 for the reminder, and the reminder message 254, are determined, they are placed in a reminder data structure 228. In some examples, the reminder data structure 228 includes a “Sender ID” field in which the sender 250 of the reminder is stored, a “Location” field in which the reminder location 258 is stored, a “Addressee ID” field in which the addressee 252 for the reminder is stored, and a “Message” field in which either the textual or audio representation of the reminder message 254 is stored.

The reminder data structure 228 is stored in a reminder database 230 for later use. While the reminder database 230 is shown as being part of the navigation system 104, it is noted that some or all of the reminder database 230 can alternatively be implemented remotely (e.g., on a remote server in the ‘cloud’). In a remote implementation, the navigation system 104 communicates with the reminder database 230 over a wireless connection such as a cellular network connection.

### 3 Reminder Presentation

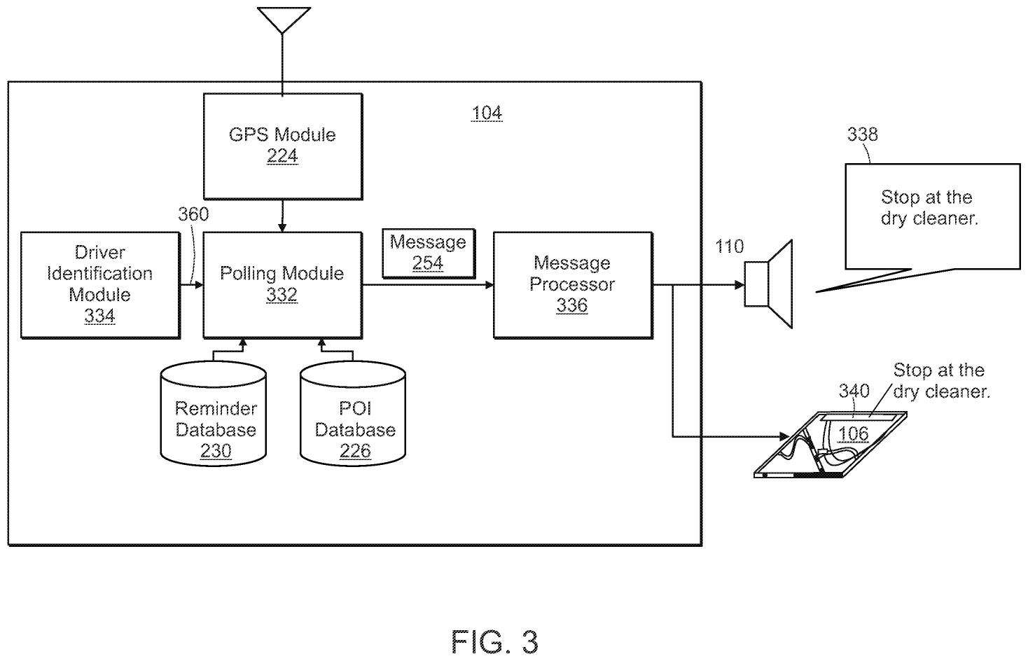

Referring to FIG. 3, after reminders are stored in the reminder database 230, the navigation system 104 polls the reminder database 230 as the vehicle travels and delivers reminders to addressees when the vehicle is in a vicinity of reminder locations.

In one implementation, the navigation system 104 includes a driver identification 334, a polling module 332, the GPS module 224, and a message processor 336.

The driver identification module 334 determines an identity 360 of the driver of the vehicle. In some examples, the driver identification module 334 determines the identity 360 of the driver based on a presence of the driver's smartphone (e.g., as determined based on a Bluetooth connection or a near field communications signal). Other identification methods such as biometrics (e.g., voice or facial recognition) or manual identification can also be used by the driver identification module 334 to identify the driver.

The driver identification module 334 provides the driver identity 360 to the polling module 332. The polling module 332 also receives a geographic position of the vehicle from the GPS module 334 and has access to the reminder database 230 and the POI database 226. In some examples, as the vehicle travels, the polling module 332 regularly (e.g., every 30 seconds or ever ½ mile traveled) polls the reminder database 230 to determine whether any reminders exist for the current geographic position of the vehicle.

As is mentioned above, there are different approaches used to specify a location for a reminder including a fixed location approach, POI based approach. The polling module 332 treats these approaches differently.

For example, if a reminder uses a fixed location approach (as in the present example), then the polling module 232 regularly polls the reminder database 230 to determine whether the any reminders with fixed locations within a predetermined distance (e.g., within ½ mile) from the geographic position of the vehicle exist. If a reminder in the reminder database 230 meets that criteria and its “Addressee ID” matches the current “Driver ID,” then the polling module forwards the message 254 from the reminder to the message processor 336.

In the POI based approach, the polling module 232 pulls all POI based reminders where the “Addressee ID” matches the current “Driver ID.” The POIs associated with those reminders are matched against all POIs within a predetermined distance (e.g., within ½ mile) from the geographic position of the vehicle. If a matching reminder is found, then the polling module forwards the “Message” 253 from the reminder to the message processor 336.

The message processor 336 processes the message 254 for presentation to the driver 102 using one or both of the loudspeaker 110 and the display 106. For example, if the message 254 is a text-based message, the message processor 336 may perform a text-to-speech (TTS) conversion so the message can be presented to the driver 102 over the loudspeaker 110. If the message 254 is an audio recording, then the message processor 336 may perform a speech recognition operation so a textual version of the message can be presented using the display 106.

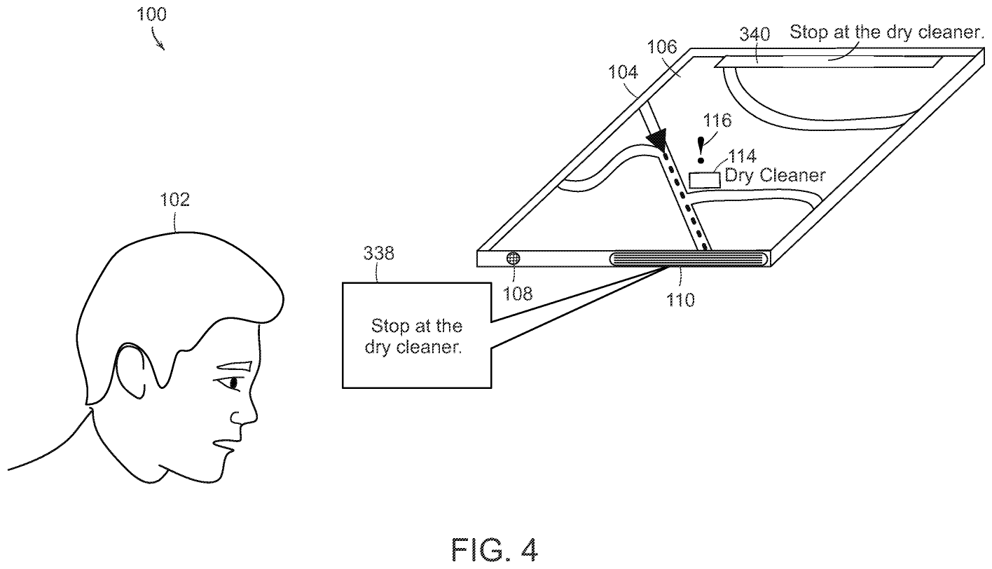

Referring to FIGS. 3 and 4, the output of the message processor 336 is presented to the user as an audio prompt 338 via the loudspeaker 110 and/or a text prompt 340 via the display 106. In the present example, as the vehicle approaches the dry cleaner 114, the polling module 332 identifies a reminder associated with the geographic location of the dry cleaner that is addressed to the driver 102. The polling module 332 provides the message “Stop at the dry cleaner” to the message processor 336, which subsequently causes an audible presentation of the message 338 via the loudspeaker 110 and a textual presentation of the message 340 via the display 106.

### 4 Alternatives

As is mentioned above, the reminder database can be a local database stored in the vehicle or a remotely stored database (e.g., in the ‘cloud’). The local database is most suitable for situations where reminders are typically directed to one's self or family members using the same vehicle. In situations where reminders are directed to to other people in other vehicles, a remotely stored database is most suitable.

As is mentioned above, for reminders to one's self, no separate addressee identifier is needed. For reminders to family members in the same vehicle (at a different time), the names of the family members can be spoken and translated into a unique identifier. For reminders to other people in other vehicles a unique identifier is required. Examples of such unique identifiers include a number/license plate of the vehicle, a telephone number or another token generated and stored in the address book (e.g. a phone application) of the vehicle. Unique identifiers can also be shared with other parties when setting up the service for the first time.

In some examples, reminders are attached to the location of the vehicle at the moment the request is spoken, as retrieved from the vehicle's GPS system. Alternatively, reminders can be attached to a location specified by the driver (per voice, “remind me when I am close to Empire State Building in NYC”) reusing, for example, the vehicle's navigation destination entry functionality, or by picking a shop category (re-using Local Search) or brand. Alternatively, also locations like “home” or “when I am on the highway”, “when I reach the city center” can be used.

In some examples, reminders are single use, while in other examples, reminders are repeated (e.g., daily). For example, a driver could set a reminder to check the child car seat when they arrive at work to ensure that they don't unintentionally leave their child in the car. In some examples, a camera might also be integrated in the system. For example, the camera could detect the child in the car seat when the car arrives at the parent's workplace and remind the parent to drop the child off at daycare. In some examples, the addressee of the reminder has an option to keep or delete the reminder.

In another application, a driver might set a reminder to take a different route than their usual route (e.g., when crossing a particular intersection) due to a road being closed for construction. In another application a person can remind another person to perform a task (e.g., a driver drops off dry cleaning, and reminds their spouse to pick it up in the evening).

In some examples, the reminders are additionally associated with times. For example, a driver could remind themselves to pick up the dry cleaning on the way home tonight.

In some examples, the navigation system can identify reminders and automatically plan routes based on those reminders (e.g., automatically route to a way point such as grocery store based on a reminder when the driver gets into the car).

In some examples, the navigation system described above is part of an infotainment (information/entertainment) computer system installed in the vehicle. In these examples, the navigation system provides location information and works with the rest of the infotainment system to manage location-aware reminders. In other examples, the term “navigation system” is used to refer to a combined navigation/infotainment computer system installed in the vehicle.

### 5 Implementations

The approaches described above can be implemented, for example, using a programmable computing system (e.g., an automobile navigation computer) executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The system may also be considered to be implemented as a tangible, non-transitory medium, configured with a computer program, where the medium so configured causes a computer to operate in a specific and predefined manner to perform one or more of the processing steps described herein.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method for managing location-aware reminders in an automobile, the method comprising:
monitoring a geographic location of the automobile using a computer system installed in the vehicle;
detecting, using the computer system, that the automobile has entered a geographic region associated with a location-aware reminder; and
issuing, from the computer system, a reminder message associated with the location-aware reminder to a driver of the automobile based on the detecting.

2. The method of claim 1 wherein the detecting that the automobile has entered a geographic region includes detecting that the automobile has entered a fixed geographic region specified in the location-aware reminder.

3. The method of claim 1 wherein the detecting that the automobile has entered a geographic region includes detecting that the automobile has entered a geographic region associated with one of a plurality of possible points of interest associated with the location-aware reminder.

4. The method of claim 1 wherein issuing the reminder message includes audibly emitting the reminder message from a loudspeaker of the reminder system.

5. The method of claim 1 wherein issuing the reminder message includes presenting a textual representation of the reminder message on a display of the computer system.

6. The method of claim 1 wherein the detecting further includes detecting that an addressee of the location-aware reminder is present in the automobile.

7. The method of claim 1 wherein the detecting further includes accessing a location-aware reminder database.

8. The method of claim 7 wherein the location-aware reminder database is stored in the automobile.

9. The method of claim 7 wherein the location-aware reminder database is stored on a remote server.

10. The method of claim 1 further comprising:
receiving, at the navigation system, a command to create the location-aware reminder,
processing the command to generate the location-aware reminder, and
storing the location-aware reminder in a location-aware reminder database.

11. The method of claim 10 wherein processing the command to generate the location-aware reminder includes determining an identity of a sender of the location-aware reminder, an addressee of the location-aware reminder, and information related to one or more geographic regions associated with the location-aware reminder.

12. The method of claim 10 wherein the addressee of the location-aware reminder is different from the sender of the location-aware reminder.

13. The method of claim 10 wherein the command is received as a voice command.

14. The method of claim 1 wherein the computer system includes a navigation system configured to monitor the geographic location of the vehicle.

15. The method of claim 1 wherein the computer system includes an infotainment system including a display through which the reminder message is issued.
